(19) United States
(12) Patent Application Publication
(10) Pub. No.: US 2019/0011765 A1
(43) Pub. Date: Jan. 10, 2019

(54) DISPLAY PANEL AND A MANUFACTURE METHOD OF DISPLAY PANEL

(71) Applicants: HKC Corporation Limited, Shenzhen city (CN); Chongqing HKC Optoelectronics Technology Co., Ltd., Chongqing (CN)

(72) Inventor: Yu-Jen Chen, Chongqing (CN)

(21) Appl. No.: 15/858,660

(22) Filed: Dec. 29, 2017

Related U.S. Application Data
(63) Continuation of application No. PCT/CN2017/101172, filed on Sep. 11, 2017.

(30) Foreign Application Priority Data
Jul. 6, 2017 (CN) 201710546130.9

(51) Int. Cl. G02F 1/1335; G02F 1/1343

(52) U.S. Cl. CPC G02F 1/133514; G02F 1/1343; G02F 1/133512

(57) ABSTRACT

A display panel and a manufacture method of display panel are provided. The display panel includes a first substrate, a second substrate, a liquid crystal layer, a light shielding layer and a plurality of color filter units. The second substrate is corresponding to the first substrate. The liquid crystal layer is formed between the first substrate and the second substrate. The light shielding layer is formed on a side of the first substrate or the second substrate, and the side is positioned toward to the liquid crystal layer. A translucent region is formed between the light shielding layers. A plurality of color filter units are formed on another side of the first substrate or the second substrate, and another side is positioned away from the liquid crystal layer. The color resist unit is correspondingly arranged to the translucent region.

### FIELD OF THE DISCLOSURE

The disclosure relates to a display technical field, and more particularly to a display panel and a manufacture method of display panel.

### BACKGROUND

Liquid crystal displays are widely applied due to numerous advantages such as thin bodies, energy saving, radiation-free, etc. Most liquid crystal displays available on the market are backlight-type liquid crystal displays, and such liquid crystal display includes a liquid crystal panel and a backlight module. The working principle of the liquid crystal panel is placing liquid crystal molecules between two parallel glass substrates and loading a driving voltage on the two glass substrates to control rotation directions of the liquid crystal molecules, for refracting rays of the backlight module to generate images.

The structure of storage liquid crystal molecules is called liquid crystal cell. There is a concept in the existing liquid crystal cell to add a white pixel for enhancing penetration specification of all bright phases. It is used to the advantage of 85% penetration white pixel and increasing brightness performance of white picture. The manufacture method of adding the white pixel is complicated because it needs five production lines for six processes. However, if there is not filled in the white pixel to the white color-resist, the inner structure of liquid crystal cell will become highly difference and it will cause poor diffusion problem of liquid crystal for example liquid crystal leakage, LC bubbles. So that the existing RGBW always select to fill in the white color-resist for planarization and it will need more processes of manufacture and cost.

It should be noted that the above introduction to the background art is only for clear and complete explanation of the technical solution of the present invention, and for the understanding by those skilled in the art. It should not be construed that the above technical solution is known to those skilled in the art as it is described in the background art.

### SUMMARY

A technical problem to be solved by the disclosure is to provide a display panel and a manufacture method of display panel without planarization process of the display panel for reducing complicated processing.

An objective of the disclosure is achieved by following embodiments. In particular, a display panel includes a first substrate, a second substrate, a liquid crystal layer, a light shielding layer and a plurality of color filter units. The second substrate is corresponding to the first substrate. The liquid crystal layer is formed between the first substrate and the second substrate. The light shielding layer is formed on a side of the first substrate or the second substrate and the side is positioned toward to the liquid crystal layer. A translucent region is formed between the light shielding layers. The plurality of color filter units are formed on another side of the first substrate or the second substrate and another side is positioned away from the liquid crystal layer. The color filter units are correspondingly arranged to the translucent region.

An objective of the disclosure is achieved by following embodiments. In particular, manufacture method of display panel includes following steps. Providing a first substrate and a second substrate. Assembling the first substrate and the second substrate. Forming a liquid crystal layer between the first substrate and the second substrate. Forming a light shielding layer on a side of the first substrate or the second substrate and forming a translucent region between the light shielding layers. The side is positioned toward to the liquid crystal layer. Forming a plurality of color filter units on another side of the first substrate or the second substrate and the color filter units are correspondingly arranged to the translucent region. Another side is positioned away from the liquid crystal layer.

In the display panel of the invention, the color resist unit is disposed on another side of the first substrate or the second substrate, and another side is outside of the liquid crystal layer. So that the shape of color resist unit does not effect to liquid crystal diffusion and arrangement, it save a step of planarization process on substrate. Also, the white pixel region could be empty and without covered by color resist, therefore the manufacture process don't need to adjustment for the fourth color resist while the fourth color resist be added to the RGB color resist unit. It can save steps of the manufacture method again. In addition, the color resist unit is RGB color resist in this invention, but also could choose other color for color-resist unit in other embodiment.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a structural schematic view of a display panel of the disclosure;

FIG. 2 is a structural schematic view of three type color filter units are arranged on the first substrate according to an embodiment of the disclosure;

FIG. 3 is a structural schematic view of four type color filter units are arranged on the first substrate according to an embodiment of the disclosure;

FIG. 4 is a structural schematic view of three type color filter units are arranged on the second substrate according to an embodiment of the disclosure;

FIG. 5 is a structural schematic view of four type color filter units are arranged on the second substrate according to an embodiment of the disclosure; and

FIG. 6 is a flow chart showing manufacture method of a highly transmission efficiency display panel of the disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

TFT LCD completes color display by liquid crystal molecule and color pixel. RGB color resist was used to display panel before, and found that the penetration of color resist is not enough in some situation, especially on bright phase. Therefore a improve design is be proposed to add a white pixel for enhancing penetration specification of all bright phases. It is used to the advantage by 85% penetration of white pixel for increasing brightness performance of white picture. But the manufacture method to add the white pixel is completely, because it needs five production lines for six processes. However, if there is not filled in the white pixel to the white color-resist, the inner structure of liquid crystal cell will become highly difference and it will cause poor diffusion problem of liquid crystal for example liquid crystal leakage, LC bubbles. So that, current RGBW are selected to fill in the fourth color-resist to planarization. In order to solve both problems described above at the same time, applicants propose the following invention.

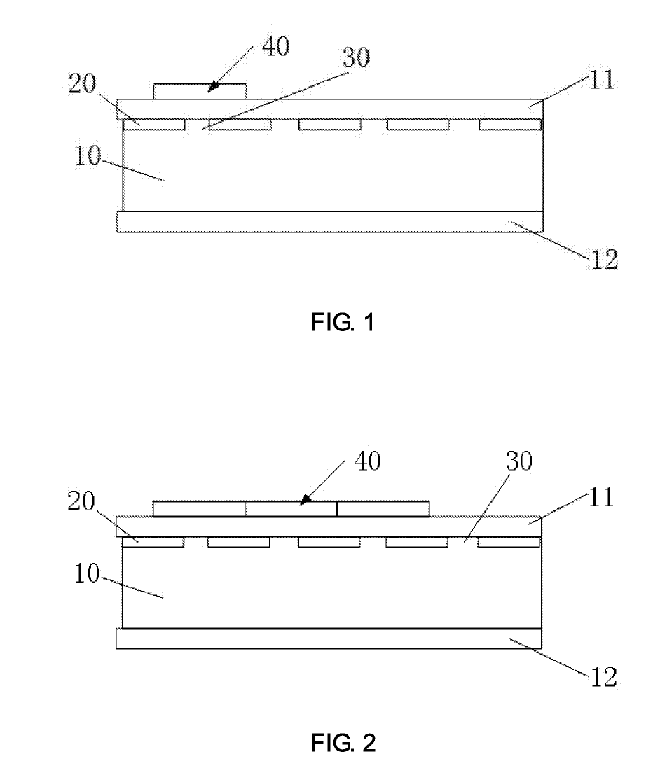

Please refer to the FIG. 1. FIG. 1 is a structural schematic view of a display panel of the disclosure. The display panel includes:

a first substrate 11,

a second substrate 12, the second substrate 12 is corresponding to the first substrate 11;

a liquid crystal layer 10, the liquid crystal layer 10 is formed between the first substrate and the second substrate;

a light shielding layer 20, the light shielding layer 20 is formed on a side of the first substrate or the second substrate, and the side is positioned toward to the liquid crystal layer, a translucent region 30 is formed between the light shielding layers; and

a plurality of color filter units 40, the plurality of color filter units 40 is formed on another side of the first substrate or the second substrate, and another side is positioned away from the liquid crystal layer, and the color filter units are correspondingly arranged to the translucent region.

In the display panel of the invention, the color resist unit is disposed on another side of the first substrate or the second substrate, and the another side is outside of the liquid crystal layer. So that the shape of the color resist unit does not affect liquid crystal diffusion and arrangement, then save steps for planarization process of substrate. Also, the white pixel region could be empty and without covered by color resist, therefore the manufacture process don't need to adjustment for the fourth color resist while the fourth color resist be added to the RGB color resist unit. It can save steps of the manufacture method again. In addition, the color resist unit is RGB color resist in this invention, but also could choose other similar color resist unit in other embodiment.

Each of the color resist unit 40 comprises a first color resist, a second color resist and a third color resist. Each of color resist unit is corresponding to four of the translucent regions 30. The first color resist, the second color resist and the third color resist are disposed outside of the liquid crystal layer and respectively corresponding to three of the four translucent regions 30. In this embodiment, the color resist unit includes the first color resist, the second color resist and the third color resist which are red color resist, green color resist and blue color resist respectively. Of course, other type of color resist unit which could improve brightness performance as the fourth color resist is also appropriate to the invention.

In this embodiment, there are four translucent regions and the color resist unit comprises a first color resist, a second color resist, a third color resist and a four color resist. Each of the color resist unit 40 (first color resist, second color resist, third color resist and fourth color resist) is corresponding to four of the translucent regions 30.

Specifically, the first color resist, the second color resist, the third color resist and the fourth color resist are arranged outside of the liquid crystal layer and respectively corresponding to four of the translucent regions 30. In this embodiment, the first color resist, the second color resist, the third color resist and the fourth color resist are arranged outside of the liquid crystal layer and respectively corresponding to four of the translucent regions 30. In this embodiment, It is could increase the brightness performance in white picture and improve the display effect in view of the highly penetration of the fourth color resist, without planarization process and saving the manufacture processes.

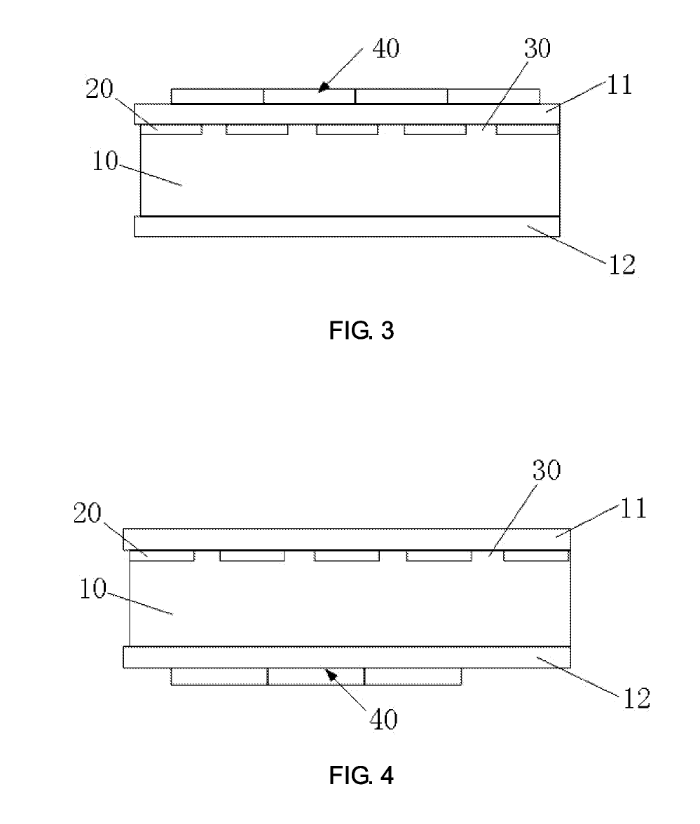

Please refer to the embodiment of the FIG. 2. FIG. 2 is a structural schematic view of three type color filter units are arranged on the first substrate according to an embodiment of the disclosure. FIG. 3 is a structural schematic view of four type color filter units are arranged on the first substrate according to an embodiment of the disclosure. Refer to the FIG. 2 and FIG. 3 and combine to the FIG. 1. In this embodiment of the invention, the color resist unit could include first color resist, second color resist and third color resist as three-resist unit, and also could include first color resist, second color resist, third color resist and fourth color resist as four-resist unit.

In this embodiment, the first substrate is an array substrate. The first substrate comprises an active switch and a pixel electrode. The second substrate is a color filter substrate. The second substrate comprises a common electrode. The active switch is electrically connected to the pixel electrode for forming an electrical field between the pixel electrode and the common electrode while switch-on, which controls the transmission rate of the liquid crystal layer so that achieve to control the display. The light shielding layer 20 is arranged on a side of the first substrate 11. The color resist unit 40 is arranged on another side of the first substrate 11 and correspondingly to the three or four of the translucent regions 30. In this embodiment, the color resist unit is arranged on another side of the first substrate and corresponding to the three of or four of the translucent regions. Just only the color resist unit is arranged on the appropriate position. In addition, the color resist won't be effect by the projections of the translucent regions so that the shape of the color resist unit could be longitudinal, trapezoidal and rectangular. The color resists of the same color resist unit better contact to each other for reducing the translucent region. If the display effect would not be affected, a little bit translucent region explored is could be accepted in other embodiments.

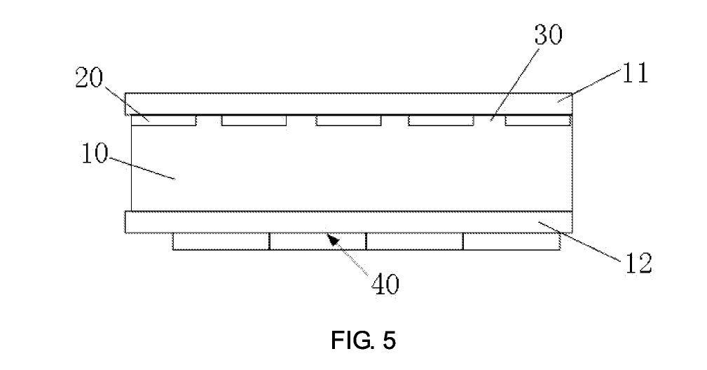

Please refer to the FIG. 4 and FIG. 5. FIG. 4 is a structural schematic view of three type color filter units are arranged on the second substrate according to an embodiment of the disclosure. FIG. 5 is a structural schematic view of four type color filter units are arranged on the second substrate according to an embodiment of the disclosure. Refer to the FIG. 4 and FIG. 5 and combine to the FIG. 1-3. In this embodiment, the color resist unit could include first color resist, second color resist and third color resist as three-resist unit, and also could include first color resist, second color resist, third color resist and fourth color resist as four-resist unit

In this embodiment, the first substrate is an array substrate. The first substrate comprises an active switch and a pixel electrode. The second substrate is a color filter substrate. The second substrate comprises a common electrode. The active switch is electrically connected to the pixel electrode for forming an electrical field between the pixel electrode and the common electrode while switch-on, which controls the transmission rate of the liquid crystal layer so that achieve to control the display. In addition, the embodiment has four translucent regions. The light shielding layer 20 is arranged in the liquid crystal layer 10 of the first substrate 11. The color resist unit 40 is arranged on another side of the second substrate and corresponding to the three or four of the translucent regions 30. In this embodiment, the color resist unit is arranged on another side of the second substrate and corresponding to the three of or four of the translucent regions. Just only the color resist unit is arranged on the appropriate position. In addition, the color resist won't be effect by the projections of the translucent regions so that the shape of the color resist unit could be longitudinal, trapezoidal and rectangular. The color resists of the same color resist unit better contact to each other for reducing the translucent region. If the display effect would not be affected, a little bit translucent region explored could be accepted in other embodiments.

In addition, a width of the color resist unit 40 is greater than the width of the translucent region 30. In this embodiment, a width of the color resist unit is greater than the width of the translucent region. The color resist should cover the light penetrated by the correspondingly translucent region for make sure display effect. Therefore only increase the width of the color resist unit could provide the effect described above. The larger of the distance between the color resist unit and the liquid crystal layer, the larger of the width of the color resist unit is required, but it's not unlimited. In general, the widest distance of the color resist unit is that two of color resists in the same unit are touch to each other.

Of course, the invention could be applied to the color filter on array (COA) display. Color filter on array (COA) display arranges the color resist and the active switch on the same substrate. In this embodiment, the substrate includes a first substrate and a second substrate. The first substrate comprises an active switch and pixel electrode. The second substrate comprises common electrode. A light shielding layer is arranged on a side of the second substrate. The color resist unit is correspondingly arranged on another side of the second substrate.

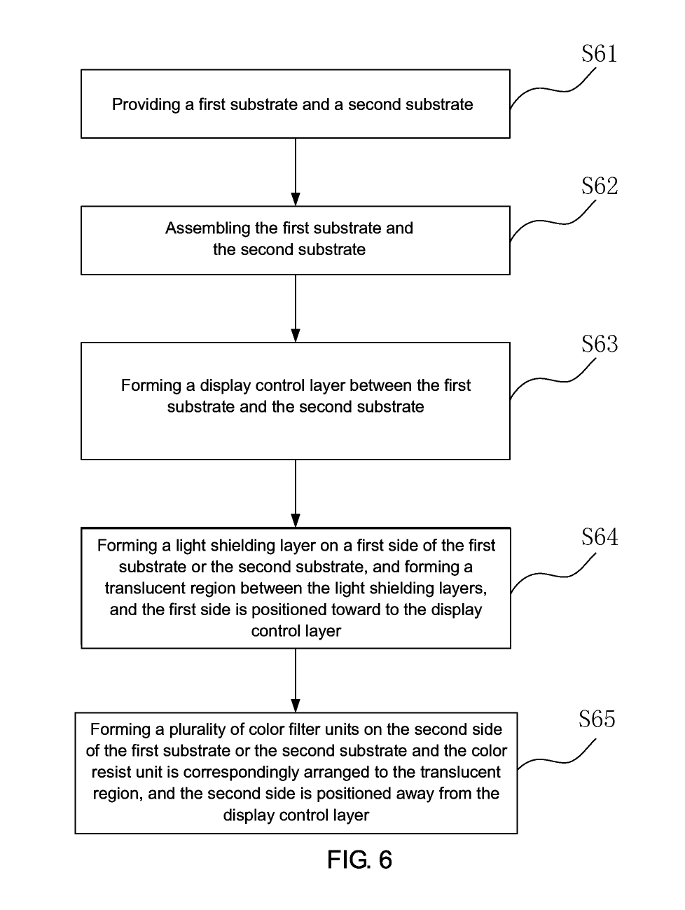

FIG. 6 is a flow chart showing manufacture method of a highly transmission efficiency display panel of the disclosure. A manufacture method of display panel comprises the following steps:
S61, providing a first substrate and a second substrate;
S62, assembling the first substrate and the second substrate;
S63, forming a liquid crystal layer between the first substrate and the second substrate;
S64, forming a light shielding layer on a side of the first substrate or the second substrate and forming a translucent region between the light shielding layers; wherein the side is positioned toward to the liquid crystal layer; and
S65, forming a plurality of color resists unit on another side of the first substrate or the second substrate and the color filter units are correspondingly arranged to the translucent region; wherein the another side is positioned away from the liquid crystal layer.

In the display panel of the invention, the color resist unit is disposed on outside of the liquid crystal layer. So that shape of the color resist unit does not effect to liquid crystal diffusion and arrangement, and save steps for planarization process of substrate. Also, the white pixel region could be empty and don't need to be covered by color resist, and the manufacture process don't need to adjustment for the fourth color resist be added to the color resist unit. It can save steps of the manufacture method again. In addition, the color resist unit is RGB color resist in this invention, but also could choose other similar color resist unit in other embodiment for example the color resist unit includes the red, green, blue and white color resist.

The specifically structure of the manufacture method of the display panel in this disclosure, please refer to the structure described above and here will not repeat again.

In the embodiment described above, the display panel could be liquid crystal panel or curve display panel.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A display panel, comprising
a first substrate;
a second substrate corresponding to the first substrate;
a liquid crystal layer formed between the first substrate and the second substrate;
a light shielding layer formed on a side of the first substrate or the second substrate and the side is positioned toward to the liquid crystal layer, and a translucent region is formed between the light shielding layers; and
a plurality of color filter units formed on another side of the first substrate or the second substrate and the another side is positioned away from the liquid crystal layer, and the color filter units are correspondingly arranged to the translucent region.

2. The display panel according to claim 1, wherein each of the color resist unit comprises a first color resist, a second color resist and a third color resist, each of color resist unit is corresponding to four of the translucent regions, and the first color resist, the second color resist and the third color resist are respectively corresponding to three of the four translucent regions.

3. The display panel according to claim 2, wherein the first substrate comprises an active switch and a pixel electrode, the second substrate comprises a common electrode, the light shielding layer is arranged on a side of the first substrate, and the color resist unit is correspondingly arranged on another side of the first substrate.

4. The display panel according to claim 2, wherein the first substrate comprises an active switch and a pixel electrode, the second substrate comprises a common electrode, the light shielding layer is arranged on a side of the first substrate, and the color resist unit is correspondingly arranged on another side of the second substrate.

5. The display panel according to claim 2, wherein the first substrate comprises an active switch and a pixel electrode, the second substrate comprises a common electrode, the light shielding layer is arranged on a side of the second substrate, and the color resist unit is correspondingly arranged on another side of the second substrate.

6. The display panel according to claim 1, wherein each of the color resist unit comprises a first color resist, a second color resist, a third color resist and a fourth color resist, each of color resist unit is corresponding to four of the translucent regions, and the first color resist, the second color resist, the third color resist and the fourth color resist are respectively corresponding to four of the translucent regions.

7. The display panel according to claim 6, wherein the first substrate comprises an active switch and a pixel electrode, the second substrate comprises a common electrode, the light shielding layer is arranged on a side of the first substrate, and the color resist unit is correspondingly arranged on another side of the first substrate.

8. The display panel according to claim 6, wherein the first substrate comprises an active switch and a pixel electrode, the second substrate comprises a common electrode, the light shielding layer is arranged on a side of the first substrate, and the color resist unit is correspondingly arranged on another side of the second substrate.

9. The display panel according to claim 6, wherein the first substrate comprises an active switch and a pixel electrode, the second substrate comprises a common electrode, the light shielding layer is arranged on a side of the second substrate, and the color resist is correspondingly arranged on another side of the second substrate.

10. The display panel according to claim 1, wherein the first substrate comprises an active switch and a pixel electrode, the second substrate comprises a common electrode, the light shielding layer is arranged on a side of the first substrate, and the color resist unit is correspondingly arranged on another side of the first substrate.

11. The display panel according to claim 1, wherein the first substrate comprises an active switch and a pixel electrode, the second substrate comprises a common electrode, the light shielding layer is arranged on a side of the first substrate, and the color resist unit is correspondingly arranged on another side of the second substrate.

12. The display panel according to claim 1, wherein the first substrate comprises an active switch and a pixel electrode, the second substrate comprises a common electrode, the light shielding layer is arranged on a side of the second substrate, and the color resist unit is correspondingly arranged on another side of the second substrate.

13. A manufacture method of display panel, comprising steps of:
providing a first substrate and a second substrate;
assembling the first substrate and the second substrate;
forming a liquid crystal layer between the first substrate and the second substrate;
forming a light shielding layer on a side of the first substrate or the second substrate, and forming a translucent region between the light shielding layers; wherein the side is positioned toward to the liquid crystal layer; and
forming a plurality of color filter units on another side of the first substrate or the second substrate and the color resist unit is correspondingly arranged to the translucent region; wherein the another side is positioned away from the liquid crystal layer.

14. The manufacture method of display panel according to claim 13, wherein each of the color resist unit comprises a first color resist, a second color resist and a third color resist, each of color resist unit is corresponding to four of the translucent regions, and the first color resist, the second color resist and the third color resist are respectively corresponding to three of the four translucent regions

15. The manufacture method of display panel according to claim 13, wherein each of the color resist unit comprises a first color resist, a second color resist, a third color resist and a fourth color resist, each of color resist unit is corresponding to four of the translucent regions, and the first color resist, the second color resist, the third color resist and the fourth color resist are respectively corresponding to four of the translucent regions.

16. The manufacture method of display panel according to claim 13, wherein the first substrate comprises an active switch and a pixel electrode, the second substrate comprises a common electrode, the light shielding layer is arranged on a side of the first substrate, and the color resist unit is correspondingly arranged on another side of the first substrate.

17. The manufacture method of display panel according to claim 13, wherein the first substrate comprises an active switch and a pixel electrode, the second substrate comprises a common electrode, the light shielding layer is arranged on a side of the first substrate, and the color resist unit is correspondingly arranged on another side of the second substrate.

18. The manufacture method of display panel according to claim 13, wherein the first substrate comprises an active switch and a pixel electrode, the second substrate comprises a common electrode, the light shielding layer is arranged on a side of the second substrate, and the color resist unit is correspondingly arranged on another side of the second substrate.

19. A display panel, comprising
a first substrate;
a second substrate corresponding to the first substrate;
a liquid crystal layer formed between the first substrate and the second substrate;
a light shielding layer formed on a side of the first substrate or the second substrate and the side is positioned toward to the liquid crystal layer, and a translucent region is formed between the light shielding layers; and
a plurality of color filter units formed on another side of the first substrate or the second substrate and the another side is positioned away from the liquid crystal layer, and the color resist unit is correspondingly arranged to the translucent region;
wherein each of the color resist unit comprises a first color resist, a second color resist, a third color resist and a fourth color resist, each of the color resist unit is corresponding to four of the translucent regions, and the first color resist, the second color resist, the third color resist and the fourth color resist are respectively corresponding to four of the translucent regions;
wherein the first substrate comprises an active switch and a pixel electrode, the second substrate comprises a common electrode, the light shielding layer is arranged on a side of the first substrate, and the color resist is correspondingly arranged on another side of the first substrate.
